(19) United States
(12) Patent Application Publication
(10) Pub. No.: US 2012/0207851 A1
(43) Pub. Date: Aug. 16, 2012

(54) Biocide compositions and related methods

(76) Inventor: Roy W. Martin, Downers Grove, IL (US)

(21) Appl. No.: 12/931,896

(22) Filed: Feb. 14, 2011

(51) Int. Cl. A01N 59/00; A01P 1/00

(52) U.S. Cl. 424/615; 424/616; 424/662; 424/665

(57) ABSTRACT

A composition for producing a biocide solution upon contact with water, the composition comprises at least a hydrogen peroxide donor and polyoxychlorine donor. The biocide solution forms reactive oxygen species when contacted by microorganisms, proteinaceous substances, and reducible organic based contaminants.

### FIELD OF INVENTION

The present invention relates to biocides and methods for killing microorganisms.

### BACKGROUND

Oxidizing biocides are commonly used for the treatment of recirculating systems such as industrial cooling systems and swimming pools, disinfecting hard surfaces, sanitizing food product surfaces, and sterilizing surgical instruments.

Chlorine dioxide is an oxychlorine compound that is an effective oxidizing biocide that is currently approved for use in these types of application.

However, chlorine dioxide while effective when in contact with most microorganisms requires as much as 1 hour contact time with 1000 ppm as ClO₂ to meet the requirements for being sporicidal using AOAC method 966.04.

Furthermore, at such high concentrations of ClO₂ needed to meet the criteria for being regarded as a sporicidal, the high volatility of chlorine dioxide can be a significant issue and health concern.

There is a need for a fast acting oxychlorine based biocide composition that can provide the benefits of chlorine dioxide without its limitations, while improving penetration of biofilms, proteinaceous deposits and accelerate inactivation of mycobacterium, spores, and oocyst at an accelerated rate.

U.S. Pat. No. 6,866,870 (“870”) discloses a biocide composition formed from ingredients comprising peroxide and a hypochlorite, wherein the biocide composition is formed by adding the peroxide ingredient to the hypochlorite ingredient so that the weight ratio of the hypochlorite to the peroxide is in the range of about 10:1 to 100:1.

The “870” patent is very limited in that: the peroxide ingredient must be added to the hypochlorite ingredient in a specific sequence; the method of producing the biocide composition requires a two-component system (bi-component); the biocide composition cannot be a solid composition; and the weight ratio of hypochlorite to peroxide must be at least 10:1, and the method of producing a biocide composition must be carried out in essentially the absence of organic matter, thereby eliminating the use of organic acids, anhydrides, surfactants and the like.

U.S. Patent Application No. 2011/0014276 A1 discloses an antimicrobial preservative for use in an ophthalmic product, the preservative comprising from about 0.005 wt. % to about 0.20 wt. % chlorite compound and from about 0.005 wt. % to about 0.05 wt. % peroxy compound, wherein the preservative does not generate chlorine dioxide, and wherein the preservative is at a pH range between about 6.0 and about 8.8.

### SUMMARY OF THE INVENTION

The present invention is deemed to meet this and other needs in a unique and highly facile way.

In one embodiment of the invention, there is provided a composition for producing a biocide solution, the composition comprising a hydrogen peroxide donor and polyoxychlorine anion donor, wherein the biocide solution is formed by adding the ingredients to an aqueous solution so that the molar ratio of the oxygen bound to the anion portion of the polyoxychlorine anion donor and the hydrogen peroxide portion of the hydrogen peroxide donor is about 50:1 to 1:2, preferably 20:1 to 1:1.

In another embodiment of the invention, there is provided a composition for producing a biocide solution, the composition comprising a hydrogen peroxide donor, a polyoxychlorine anion donor and an acid donor, wherein the biocide composition is formed by adding the ingredients to water to so that the molar ratio of the oxygen bound to the anion portion of the polyoxychlorine anion donor and the hydrogen peroxide portion of the hydrogen peroxide donor is about 50:1 to 1:2, preferably 20:1 to 1:1. The pH can be optimized based on the needs of the application and typically ranges from about 3.0 to 10.0, more preferably 4.0 to 9.0, and most preferred 5.0 to 8.5.

In another embodiment of the invention, there is provided a composition for producing a biocide solution, the composition comprising a hydrogen peroxide donor, a polyoxychlorine anion donor and an acid anhydride, wherein the biocide composition is formed by adding the ingredients to water to so that the molar ratio of the oxygen bound to the anion portion of the polyoxychlorine anion donor and the hydrogen peroxide portion of the hydrogen peroxide donor is about 50:1 to 1:2, more preferably 20:1 to 1:1. The pH can be optimized based on the needs of the application and typically ranges from about 3.0 to 10.0, more preferably 4.0 to 9.0, and most preferred 5.0 to 8.5.

The composition of the invention allows for a biocide solution using peroxychlorine anion donors having 3 moles and 4 moles of oxygen measured as elemental oxygen without the formation of chlorine dioxide. However, the addition of a polyoxychlorine anion having 2 moles of oxygen measured as elemental oxygen allows for the formation of a biocide solution with at least some proportion of chlorine dioxide.

In another embodiment of the invention, there is provided a composition for producing a biocide solution, the composition comprising a peroxymonosulfate donor, a polyoxychlorine anion donor and an acid anhydride, wherein the biocide composition is formed by adding the ingredients to water to so that the molar ratio of the oxygen bound to the anion portion of the polyoxychlorine anion donor and the hydrogen peroxide portion of the hydrogen peroxide donor is about 50:1 to 1:2, preferably 20:1 to 1:1. The pH can be optimized based on the needs of the application and typically ranges from about 3.0 to 10.0, more preferably 4.0 to 9.0, and most preferred 5.0 to 8.5.

In another embodiment of the invention, a method is provided which comprises contacting a microorganism with a biocidally effective amount of a biocide solution according to this invention.

### DETAILED DESCRIPTION OF THE EMBODIMENT(S)

It has been discovered that combining an alkali metal salt of polyoxychlorine anions with a hydrogen peroxide donor results in the formation of a biocide solution with substantially enhanced utility and ability to penetrate proteinaceous deposits and biofilms.

The use of polyoxychlorine anions dramatically increases the stability of the biocide solution until such time the solution contacts microorganisms, proteinaceous deposits and suspensions and reducible organic based compounds. The compositions of the inventions and their respective biocide solutions demonstrate excellent compatibility with many organic acids, acid anhydrides, and surfactants such a block copolymers exemplified by Pluronic 31R1. This greatly expands their use in formulations and applications where detergency, increased wetting, and dispersants are beneficial.

Furthermore, the use of polyoxychlorine anions of the invention greatly increases the oxidative activity of the biocide solution produced. It has been discovered that the oxidative activity is increased as the moles of oxygen bound to the anion portion of the polyoxychlorine anion donor increases. Surprisingly, the biocide solutions comprising polyoxychlorine anions having higher molar levels of oxygen demonstrate improved storage stability until such time as they contact a reducible substance, at which time they demonstrate more aggressive decomposition of the reducible substance. This observation holds true even when the comparisons are made based on biocide solutions having comparable molar ratios of oxygen reported as elemental oxygen from different sources of polyoxychlorine anion donors. This indicates the source of the oxygen is as much a factor as the concentration of oxygen in the biocide solution. Furthermore, a biocide solution resulting from polyoxychlorine anions having 3 moles (chlorates) and 4 moles (perchlorates) of oxygen bound to the anion portion of the polyoxychlorine anion donor is substantially free of chlorine dioxide. There is no indication of chlorine dioxide in the resulting solution even with relatively high concentrations of ingredients comprising greater than 4 wt % of the solution.

The compositions of the invention can comprise a solid composition. The solid compositions may be in the form of a powder, granules and tablet. The solid compositions may comprise a mixture of all ingredients, or may comprise two or more solids that are separated and can be premixed prior to addition to water, or added separately to water to form the biocide solution.

The use of polyoxychlorine anions eliminates the restrictions and limitations encountered when using hypochlorites as disclosed in U.S. Pat. No. 6,866,870. Organics such as succinic acid and succinic anhydride can be included in the compositions of the invention as well as the biocide solution. The compositions can be added as one or in any combination. The compositions of the invention can be in the form of a solid since there are no restrictions on how the ingredients of the composition are added.

As used herein, the term “water” includes aqueous solutions that comprise water. The use of the term water is not to imply the water is pure or removed of all mineral salts and gases common to most waters.

As used herein, the term “recirculating systems” describes any open aqueous system that consist of a reservoir of water and a system of piping to transport the water, and wherein the water transported through the piping is eventually returned to the reservoir. Examples of recirculating systems include but are not limited to: cooling systems such as cooling towers and cooling ponds, swimming pools, fountains and feature pools.

As used herein “food processing applications” include those aspects within the process that utilize antimicrobial treatments to reduce the potential of spread of infectious disease. Applications include: vegetable and fruit washing; cleaning and sanitizing of food processing equipment; cleaning and sanitizing of animal carcasses, poultry, meat, rabbit, and egg products, treatment of poultry and animal habitats.

As used herein, “food product surfaces” include: meat carcasses of beef, pork, poultry, and fish; fruit surfaces, and vegetable surfaces.

As used herein, “hard surfaces” include: countertops; floors; walls; tables; cabinets; doors; doorknobs; food processing equipment, and the like.

As used herein, “surgical instruments” include: endoscopes; scalpels; forceps, and other instruments that require sterilization.

As used herein, “acid donor” describes compounds that contribute hydrogen ions (H⁺) when dissolved in water. Acid donors can be inorganic and organic. Specific non-limiting examples of inorganic acid donors include but are not limited to sodium bisulfate, potassium bisulfate, sodium pyrosulfate, and potassium pyrosulfate. Specific non-limiting examples of organic acid donors include maleic acid, malonic acid, fumaric acid, succinic acid , tartaric acid. Non-reducible organic acid donors are preferred.

As used herein, “acid anhydride” describes compounds two acyl groups bound to the same oxygen atom. Specific non-limiting examples of acid anhydrides include but are not be limited to succinic anhydride, maleic anhydride, N-caprylic anhydride, acetic anhydride, and the like.

As used herein, “polyoxychlorine anion donor” is selected from an alkali and alkali earth metal chlorite (ClO₂⁻), alkali and alkali earth metal chlorate (ClO₃⁻), and alkali and alkali earth metal perchlorate (ClO₄⁻). Examples include but are not be limited to: sodium chlorite, potassium chlorite, magnesium chlorite, calcium chlorite, sodium chlorate, potassium chlorate, magnesium chlorate, calcium chlorate, sodium perchlorate, potassium perchlorate, magnesium perchlorate, calcium perchlorate.

As used herein, “oxygen bound to the anion portion of the polyoxychlorine anion donor” describes the number of moles of oxygen reported as elemental oxygen in the anion portion of the polyoxychlorine compound. For example, sodium chlorite having the general formula NaClO₂ comprises the polyoxychlorine anion ClO₂⁻ which has two moles of oxygen reported as elemental oxygen.

As used herein, “hydrogen peroxide donor” describes a source of hydrogen peroxide having the general formula H₂O₂. Hydrogen peroxide donors useful in the practice of this invention include hydrogen peroxide, alkali and alkali earth metal peroxides as well as other metal peroxides. Specific non-limiting examples include sodium perborate, sodium percarbonate, calcium peroxide, magnesium peroxide, sodium peroxide, potassium peroxide, and the like, and aqueous solutions comprising percarboxylic acid exemplified by peracetic acid, persuccinic acid, and peroctanoic acid.

As used herein, “percarboxylic acid donor” describes ingredients for either in-situ generation of percarboxylic acid or an ex-situ source of percarboxylic acid. Ingredients for in-situ generation of percarboxylic acid include an acid anhydride exemplified by but not limited to succinic anhydride and maleic anhydride, and a hydrogen peroxide donor exemplified by but not limited to hydrogen peroxide, sodium percarbonate, and sodium peroxide. The ex-situ source of percarboxylic acid is a ready-made solution comprising percarboxylic acid. Examples include but are not limited to persuccinic acid, peracetic acid, permaleic acid, and peroctanoic acid.

As used herein, “reactive oxygen species” are any combination of variants of oxygen and oxygen radicals that are effective oxidizers, and as such reduce reducible substance. Specific non-limiting examples of reactive oxygen species include but are not limited to singlet oxygen, superoxide, and hydroxyl radicals.

As used herein, “biocide solution” describes solutions comprising the compositions of the invention. The compositions and their respective biocide solutions can be optimized to meet the requirements to be classified as a disinfectant, sanitizer, and/or sterilant.

As used herein, “effective amount of percarboxylic” describes the presence of at least one percarboxylic acid in sufficient concentration as to promote the formation of reactive oxygen species when the biocide solution comprising a polyoxychlorine anion donor is contacted by microorganisms, proteinaceous substances, and/or reducible organic based contaminants.

As used herein, “hydrogen peroxide portion of the hydrogen peroxide donor” describes the amount of hydrogen peroxide generated or released when the hydrogen peroxide donor is dissolved in water. For example, 1 mole of sodium percarbonate contributes 3 moles of hydrogen peroxide.

As used herein, “proteinaceous substances” describes any of a group of complex organic macromolecules that contain carbon, hydrogen, oxygen, nitrogen, and usually sulfur and are composed of one or more chains of amino acids. Proteins are fundamental components of all living cells and include many substances, such as enzymes, hormones, and antibodies, that are necessary for the proper functioning of an organism. The proteinaceous substances are also protein based substances used as binder and source of oxidizer demand in AOAC official method 966.04 for testing sporicidal activity of disinfectants.

As used herein, “reducible organic based contaminants” are carbon based compounds that can be at least partially reduced by reactive oxygen species.

As used herein, “weight percent” and “wt %” unless otherwise stated is based on the total weight of the biocide solution.

As used herein, “effective amount of combustion suppressing boron donor” defines an effective amount of boron containing compound exemplified by borax and boric acid that can reduce the combustion rate of the solid composition to a packing group having lower transportation and/or storage restrictions. Division 5.1 Oxidizer Testing in accordance with the Code of Federal Regulations, Title 49, and the United Nations Transportation of Dangerous Goods-Manual of Test and Criteria, Fourth revised edition (2003). Solid Division 5.1 materials are assigned packing groups using the following criteria [49 CFR .sctn.173.127(b)]: (i) Packing Group I is the sub-classification of any material which, in the 4:1 or 1:1 sample to cellulose ratio (by mass) tested exhibits a mean burning time less than the mean burning time of a 3:2 mixture, by mass, of potassium bromate and cellulose. (ii) Packing Group II is the sub-classification of any material which, in the 4:1 or 1:1 sample to cellulose ratio (by mass) tested exhibits a mean burning time less than the mean burning time of a 2:3 mixture, by mass, of potassium bromate and cellulose, and the criteria for Packing Group I are not met. (iii) Packing Group III is the sub-classification of any material which, in the 4:1 or 1:1 sample to cellulose ratio (by mass) tested exhibits a mean burning time less than the mean burning time of a 3:7 mixture, by mass, of potassium bromate and cellulose, and the criteria for Packing Groups I and II are not met.

As used herein, the term “tablet” refers to any geometric shape or size that comprises at least the ingredients of the compositions of the invention. The ingredients of the composition are agglomerated into a single mass to form a tablet. The tablet, upon contact with water produces a biocide solution.

As used herein, the term “multi-tablet chemical dispenser” describes any convenient feed system that holds multiple tablets of the invention and contacts at least some portion of the tablets with an aqueous solution to produce a solution consisting of at least chlorine dioxide. Examples include flow-thru brominators such as those sold by Great Lakes Water Treatment, Nalco Chemical, and BetzDearborn Inc. whose disperser is exemplified in U.S. Pat. No. 5,620,671, spray feeders like those sold by Arch Chemical and sold under the trade name Pulsar, floating dispensers, or a perforated dispenser such as a minnow bucket or strainer that is immersed into the aqueous solution.

As used herein, the term “bulk packaging” defines the ability to package a plurality of tablets into one package without segregating each tablet. Example packaging includes but is not limited to plastic bags and/or plastic pails. Bulk packaging requires the tablet possess sufficient environmental and chemical stability as to substantially eliminate the potential for formation of chlorine dioxide during packaging, storage and transport.

Hydrogen peroxide donors useful in the practice of this invention include hydrogen peroxide, alkali and alkali earth metal peroxides as well as other metal peroxides. Specific non-limiting examples include sodium perborate, sodium percarbonate, calcium peroxide, magnesium peroxide, sodium peroxide, potassium peroxide, and the like.

Polyoxychlorine anion donors useful in the practice of the invention include alkali metal and alkali earth salts of chlorite, chlorate, and perchlorate. Specific non-limiting examples include sodium chlorite, potassium chlorite, calcium chlorite, magnesium chlorite, sodium chlorate, potassium chlorate, magnesium chlorate, calcium chlorate, sodium perchlorate, potassium perchlorate, magnesium perchlorate, calcium perchlorate.

Acid donors can be inorganic and organic. Specific non-limiting examples of inorganic acid donors include but are not limited to sodium bisulfate, potassium bisulfate, sodium pyrosulfate, and potassium pyrosulfate. Specific non-limiting examples of organic acid donors include maleic acid, malonic acid, fumaric acid, succinic acid, tartaric acid. Non-reducible organic acid donors are preferred.

Acid anhydrides suitable for use in this invention are those that react with hydrogen peroxide to produce percarboxylic acid. Specific non-limiting examples of acid anhydrides include but are not be limited to succinic anhydride, maleic anhydride, N-caprylic anhydride, acetic anhydride, and the like.

Solid compositions of this invention may be in the form of powders, granules, and tablets. Solid composition may be packaged as a single composition, or as separate ingredients to be later mixed then added to water or individually added to water.

Solid compositions in the form of a tablet can be formed into a biocide solution using a multi-tablet chemical dispenser for ease of producing the biocide solution for higher use applications such as cooling towers and swimming pools. Tablets can also be packaged using bulk packaging.

Solid compositions in the form of granules and powders maybe dissolved in water then fed thru a chemical pump, fed thru a shot feeder wherein the solid composition is placed into a vessel, the vessel is sealed, and water is piped into the vessel to dissolve the composition, form the biocide solution, and dispense the biocide solution to the aqueous system to be treated such as a cooling tower, swimming pool, spa, and the like.

Solid compositions may be packaged in single use packages for producing a biocide solution for disinfection hard surface such as counter tops, doorknobs, cabinets, and the like.

Additionally, solid compositions may be packaged in single use packages can be used for producing a sterilant for use in hospitals and emergency medical units such as military field hospitals.

Solid compositions can also be packaged as bleaches for laundry or formulated with dry or non-aqueous laundry detergents.

Further still, solid compositions can be used to produce biocide solutions for the treatment of food product surfaces such as carcasses of beef, pork, poultry and fish products.

Solid compositions can also be used to disinfect food processing equipment and animal habitats.

Compositions can also comprise liquids, and/or liquids and solids to produce the biocide solution. A biocide solution can be prepared by adding liquid ingredients or liquid and solid ingredients to produce a biocide solution comprising a weight percent of ingredients of at least 0.3 wt %, preferably at least 0.5 wt %, and most preferably at least 1 wt %. The ingredients and water should be mixed to form a homogenous solution. The resulting biocide solution can be diluted with water prior to use.

Compositions of the invention can be formed into a biocide solution using any convenient means such as a chemical tank and mixer fitted with a chemical feed pump for treating applications such as cooling towers and swimming pools.

Compositions of the invention can be fed thru a shot feeder wherein the composition is placed into a vessel, the vessel is sealed, and water is piped into the vessel to dissolve the composition, form the biocide solution, and dispense the biocide solution to the aqueous system to be treated such as a cooling tower, swimming pool, spa, and the like.

Compositions of the invention may be packaged in single use packages for producing a biocide solution for disinfection hard surface such as counter tops, doorknobs, cabinets, and the like.

Additionally, compositions of the invention may be packaged in single use packages can be used for producing a sterilant for use in hospitals and emergency medical units such as military field hospitals.

Compositions of the invention can also be packaged as bleaches for laundry or formulated with laundry detergents.

Further still, compositions of the invention can be used to produce biocide solutions for the treatment of food product surfaces such as carcasses of beef, pork, poultry and fish products.

Compositions of the invention can also be used to disinfect food processing equipment and animal habitats.

Surfactants can be incorporated into the composition or the biocide solution to reduce the surface tension, improve wetting, improve detergency, and provide foaming capability. Specific non-limiting examples include block copolymer surfactants sold under the trade name Pluronic® manufactured by BASF.

Anti-caking agents can improve flowability and reduce clumping of dry compositions and ingredient. I can be advantageous to apply an anti-caking agent exemplified by magnesium carbonate light, untreated fumed silica and treated fumed silica. Fumed silica is sold under the trade name CAB-O-SIL® and is manufactured by Cabot Corporation. Anti-caking agents can also reduce the hygroscopic nature of the polyoxychlorine anion donors as well as the entire solid composition.

Dispersants such as tripolyphosphate can be useful in dispersing soils in sterilant and other applications in which the biocide solution must penetrate deposits to effectively inactivate microorganisms.

### Testing

AOAC method 966.04 is used to determine the sporicidal efficacy of an antimicrobial agent. The test uses ceramic cylinders that have been placed in a suspension of proteinaceous materials and soils which had been inoculated with Bacillus subtilis. The coated cylinders are removed from the suspension and dried. This preparation embeds the spores in a heavily soiled proteinaceous matrix that protects the spores from the sporicide. The normally white ceramic cylinders acquire beige to tan color with some having brown areas due to heavier deposition.

Samples of the prepared ceramic cylinders where obtained from MicroChem laboratory Inc. of Euless, Tex.

All of the stock biocide solutions used in the test where prepared by mixing solid ingredients then adding the listed ingredients into 100 ml of water and mixing using a magnetic stirrer until clear and no suspended solids were observed. The activity of the biocide solution was tested by using the stock biocide solution as prepared, or by diluting the stock biocide solution, filling a vial to the 10 ml mark, then adding one of the prepared ceramic cylinders used for sporicidal testing. A stop watch was started when the ceramic cylinder was added, and observations were made to assess the speed and aggressiveness of the reaction by observing the rate at which gas was formed on the cylinder, the relative amount of gas released, the time lapsed until the gas formation terminated, and the color of the ceramic cylinder upon completion of either the termination of gas formation or termination of the test.

Samples of biocide solutions were prepared by combining measured amounts ingredients illustrated in Table 1, then adding them to 100 ml of water while mixing using a magnetic stirrer. In test 1, the amount and source of acid donor and hydrogen peroxide donor were the same. The amount of peroxychlorine anion donor was altered to provide comparable molar ratios of oxygen measured as elemental oxygen. The amount added takes into consideration the activity of the ingredients being used (82% NaClO₂, 99% NaClO₃).

TABLE 1

| | | | | Succinic | | Ceramic Cylinder in 10 ml |
|---|---|---|---|---|---|---|
| | NaClO₂ | NaClO₃ | Percarbonate | Acid | | AOAC 966.04 |
| Sample | gm | gm | gm | gm | Sequence | 1 min. Observation |
| #1A | na | 0.71 gm | 2.10 gm | 2.00 gm | mixture | No relevant reaction |
| | | | | | | pH 5.72 |
| | | | | | | Slow reaction - gas |
| #2A | 1.10 gm | na | 2.10 gm | 2.00 gm | mixture | formation, pH 5.75 |

The results of Table 1 illustrate under the conditions tested, the chlorate did not work synergistically with the hydrogen peroxide using succinic acid as the acid donor. However chlorite did induce a reaction in the presence of hydrogen peroxide with succinic acid as the acid donor. Results further show that combining the ingredients of sample #2 to form a mixture, and adding the mixture to water in a ratio that provides approximately a 1:1 molar ratio of oxygen (measured as elemental oxygen) to hydrogen peroxide, resulted in a favorable decomposition of the proteinaceous deposit on the ceramic cylinder.

As illustrated in table 1, the polyoxychlorine anion donor (sodium chlorate) having at least 3 moles of oxygen measured as elemental oxygen did not synergistically react in the presence of hydrogen peroxide and succinic acid. In this test, polyoxychlorine anion donors providing 3 moles (sodium chlorate) and 4 moles (magnesium perchlorate) of oxygen measured as elemental oxygen where tested in combination with hydrogen peroxide donor and succinic anhydride. Equal amounts of hydrogen peroxide donor and succinic anhydride were combined with two different sources of polyoxychlorine anion donor.

TABLE 2

| | Sodium | Magnesium | Sodium | Succinic | | |
|---|---|---|---|---|---|---|
| Sample | Chlorate | Perchlorate | Percarbonate | Anhydride | Sequence | Observation |
| #5A | 1.00 gm | na | 2.00 gm | 1.50 gm | mixture | pH 6.77 |
| | | | | | | Aggressive reaction |
| | | | | | | 30 seconds |
| | | | | | | reaction complete |
| | | | | | | cylinder white |
| #6A | na | 1.00 gm | 2.00 gm | 1.50 gm | mixture | pH 6.73 |
| | | | | | | Aggressive reaction |
| | | | | | | 15-20 seconds |
| | | | | | | reaction complete |
| | | | | | | cylinder white |

The results unexpectedly illustrate that polyoxychlorine anion donors with 3 or more moles of oxygen in the presence of hydrogen peroxide and succinic anhydride provided a biocide solution with a high level of reactivity toward the proteinaceous deposits. For comparison, table 1 illustrated the sodium chlorite had no relevant reaction using succinic acid, but table 2 illustrates a very favorable reaction when using succinic anhydride. The sample using magnesium perchlorate showed the potential for even more favorable results than the sodium chlorate sample. This may be due to the higher level of oxygen being liberated from the perchlorate. Furthermore, there was no indication of chlorine dioxide being generated in the biocide solution.

TABLE 3

| Sample | 24 hr | 48 hr |
|---|---|---|
| #5A | 2 ml soln to 8 ml water | 2 ml soln to 8 ml water |
| | (0.90 wt % solids) | (0.90 wt % solids) |
| | bubble formation on surface | Same observations as |
| | evolution of gas - increased with | 24 hr test |
| | movement. 4.5 minutes cylinder | Activity remains high |
| | is white. No apparent gas formation | |
| #6A | 2 ml soln to 8 ml water | 2 ml soln to 8 ml water |
| | (0.90 wt % solids) | (0.90 wt % solids) |
| | Readily forms gas with evolution | Comparable to 24 hr test. |
| | Reaction nears completion | Cylinder is white and gas |
| | is 2 min. cylinder white in | formation completed in |
| | appearance | approx 2 minutes |

Table 3 comprises data from follow-up test for samples of biocide solution produced in support of the data in table 2. These tests illustrate the relative stability of the biocide solution after 24 hrs and 48 hours of storage. The biocide sample identified as #5A and #6A where diluted with fresh water to achieve approximately a 0.9 wt % solids (ingredients). The results unexpectedly show the samples remained highly active and imparted a strong reaction with the proteinaceous deposits on the ceramic cylinders. Furthermore, there was no indication of chlorine dioxide generation in the biocide solution.

TABLE 4

| Sample | Sodium | Succinic | | |
|---|---|---|---|---|
| Peracid | Percarbonate | Anhydride | Sequence | Observations |
| | 3.00 gm | 3.00 gm | mixture | pH 6.56 |
| | | | | 2 ml soln to 8 ml water |
| | | | | slow gas formation |
| | | | | no continued gassing |
| | | | | deposits remain after |
| | | | | 10 min cylinder white |
| | | | | after 20 min |

Table 4 demonstrates the results of a solution comprising persuccinic acid produced by reacting 3.0 gm sodium percarbonate with 3.0 gm succinic anhydride in 50 ml of water for 30 minutes followed by dilution with another 50 ml of water. The final dilutions used to treat the ceramic cylinder provided a higher concentration of actives than for the examples of biocide solutions of the invention illustrated in tables 2 and 3. The persuccinic acid did not demonstrate the ability to decompose the proteinaceous deposits at a rate comparable to the 5. composition of the invention.

Therefore it can be concluded the improved results achieved by combining polyoxychlorine anion donors having 3 moles and 4 moles of oxygen measured as elemental oxygen with a hydrogen peroxide donor and succinic anhydride is not the result of forming persuccinic acid. Without being bound by any theory the accelerated rate of decomposition of the proteinaceous deposits is believed to be the result of the formation of oxygen based intermediates that target the bonds comprising the deposit.

TABLE 5

| | Sodium | Magnesium | Sodium | Succinic | Sequence | Observation |
|---|---|---|---|---|---|---|
| SAMPLE | Chlorate | Perchlorate | Percarbonate | Anhydride | Addition | ceramic cylinder |
| Suprastoich | | | | | | |
| H₂0₂ to 0⁼ | 1.0 gm | na | 3.0 gm | 3.0 gm | mixture | pH 6.40 |
| | | | | | | 2.0 ml soln to 8 ml water |
| | | | | | | gas slowly forms on surface |
| | | | | | | gas does not dissipate |
| | | | | | | not aggressive but reacting |
| | | | | | | stock soln gassing |
| | | | | | | continually |
| 0⁼ to H₂0₂ | na | 3.0 gm | 2.0 gm | 2.0 gm | mixture | pH 5.90 |
| | | | | | | 1.3 ml soln to 8.7 ml water |
| | | | | | | Immediate gas evolution |
| | | | | | | 2 min complete |
| | | | | | | cylinder white |

Table 5 illustrate the results of two biocide solutions using two different supra-stoichiometric ratios of hydrogen peroxide and elemental oxygen. The sample identified as Supra-stoich H₂O₂ to O⁼ has a molar excess hydrogen peroxide. The sample identified as Supra-stoich O⁼ to H₂O₂ has a molar excess of oxygen measured as elemental oxygen. Neither of the samples illustrates any formation of chlorine dioxide.

TABLE 6

| Sample | NaClO₃ | Percarbonate | Sequence | Observation |
|---|---|---|---|---|
| Alkaline | 1.00 gm | 2.00 gm | mixture | pH 9.8 |
| | | | | gas formation of surface |
| | | | | Slow compared to |
| | | | | Succinic anhydride |
| | | | | samples |

Table 6 demonstrates the ability of a biocide solution resulting from an alkaline based composition of the invention. While demonstrating efficacy, the performance was not comparable in performance to biocide solutions that result from composition of the invention that include succinic anhydride. The biocide solution had no indication of chlorine dioxide generation.

TABLE 7

| | Sodium | Sodium | Succinic | | |
|---|---|---|---|---|---|
| SAMPLE | Chlorite | Perborate | Anhydride | Sequence | Observation |
| #1 | 1.0 gm | 1.5 gm | 1.5 gm | perborate + | bright yellow |
| 50 ml | | | | Anhydride | soln |
| | | | | pH 5.12 | clear - stable |
| | | | | then add | |
| | | | | chlorite | |
| | | | | pH 5.12 | |

Table 7 illustrates the results of a composition of the invention that also produces chlorine dioxide in the biocide solution. The addition of a polyoxychlorine donor having 2 moles of oxygen measured as elemental oxygen induced generation of chlorine dioxide. However, in all samples using only polyoxychlorine anion donors having 3 moles and 4 moles of oxygen measured as elemental oxygen did not produce chlorine dioxide.

TABLE 8

| SAMPLE | 24 hr | 7 days |
|---|---|---|
| #1 | 1526 ppm ClO2 | 1274 ppm ClO2 |

Table 8 illustrates the stability of samples retained from the biocide solution produced and represented in table 7 after 24 hours and 7 days.

The test results indicate while polyoxychlorine anion donors having 2 moles of oxygen measured as elemental oxygen react favorably in an aqueous solution comprising hydrogen peroxide and succinic acid, while polyoxychlorine anion donors having from 3 moles to 4 moles of oxygen measured as elemental oxygen do not.

However, when chlorate anions having 3 moles and perchlorate anions having 4 moles of oxygen measured as elemental oxygen are in an aqueous solution treated with hydrogen peroxide donor and an acid anhydride, the decomposition of proteinaceous deposits is unexpectedly quite vigorous, even at relatively low concentrations.

The inventor, without being bound to a specific theory, proposes the following mechanisms resulting in the novel biocide compositions and resulting biocide solutions. The reaction between hypochlorite and hydrogen peroxide to produce singlet oxygen has been known and well documented in literature. The bond between the chlorine and oxygen is a single bond that extends off the chlorine with no impediments to interfere with electron transfer and cleavage.

Chlorite anion comprises single bonded oxygen and a double bonded oxygen with the chlorine. When exposed to an aqueous solution containing hydrogen peroxide, the oxygen possessing the single bonded with chlorine is likely cleaved to liberate singlet oxygen, like that between the hydrogen peroxide and hypochlorite. However, the remaining oxygen is less susceptible to cleavage. The chlorate and perchlorate have two and three double bonded oxygen respectfully. Likely due to increased steric hindrance, the hydrogen peroxide is not reduced at an effective rate to provide the desired performance.

However, the formation of a peroxyacid by reaction between, in the case of the examples provide in tables 1-8, succinic anhydride and hydrogen peroxide, the persuccinic acid functions as a suitable adjuvant to induce electron transfer and cleavage of the oxygen, including at least some of the double bonded oxygen. The liberation of otherwise stable oxygen on the chlorate and perchlorate would explain the increases effectiveness of the perchlorate over chlorate as illustrated in tables 2 and 3. The exact sequence is not known, but the increased availability of reactive oxygen is apparent based on the differences in the rate of reaction despite using comparable concentrations of ingredients.

What is claimed is:

1. A composition for producing a biocide solution upon contact with water, the composition comprising:
a hydrogen peroxide donor;
an acid anhydride;
a polyoxychlorine anion donor;
the proportion of polyoxychlorine anion donor being based on the molar ratio of oxygen bound to the anion portion of the polyoxychlorine anion donor and the hydrogen peroxide portion of the hydrogen peroxide donor, the molar ratio being about 50:1 to 1:2 respectively;
the acid anhydride in sufficient amount to produce an effective amount of percarboxylic acid when the composition is contacted with water; and
wherein the biocide solution forms reactive oxygen species when contacted by microorganisms, proteinaceous substances, and reducible organic based contaminants.

2. The composition according to claim 1, wherein the hydrogen peroxide donor is selected from at least one of sodium perborate and sodium percarbonate.

3. The composition according to claim 1, wherein the hydrogen peroxide donor is selected from at least one of sodium peroxide and hydrogen peroxide.

4. The composition according to claim 1, wherein the acid anhydride comprises succinic anhydride.

5. The composition according to claim 1, wherein the polyoxychlorine donor is selected from at least one of an alkali and alkali earth metal of chlorite, chlorate and perchlorate.

6. The composition according to claim 5, wherein the polyoxychlorine donor is selected from at least one of sodium chlorite, potassium chlorite, calcium chlorite, magnesium chlorite, sodium chlorate, potassium chlorate, calcium chlorate, magnesium chlorate, sodium perchlorate. potassium perchlorate, calcium perchlorate, magnesium perchlorate.

7. The composition according to 1, wherein the polyoxychlorine donor is selected from at least one of: an alkali and alkali earth metal of chlorate; and alkali and alkali earth metal perchlorate.

8. The composition according to claim 1, wherein the molar ratio of oxygen bound to the anion portion of the polyoxychlorine anion donor and the hydrogen peroxide portion of the hydrogen peroxide donor being about 20:1 to 1:1.

9. The composition according to claim 1, wherein the biocide solution further comprises at least one of chlorous acid a chlorine dioxide.

10. The composition according to claim 1, wherein the biocide solution is substantially free of chlorine dioxide.

11. The composition according to claim 1, wherein the composition is a solid composition.

12. The composition of claim 11, wherein the solid composition is in the form of a powder.

13. The composition of claim 11, wherein the solid composition is in the form of granules.

14. The composition of claim 11, wherein the solid composition is in the form of a tablet.

15. A biocide solution comprising water, and at least a 0.5 wt % of a composition comprising:
a hydrogen peroxide donor;
a polyoxychlorine anion donor;
the proportion of polyoxychlorine anion donor being based on the molar ratio of oxygen bound to the anion portion of the polyoxychlorine anion donor and the hydrogen peroxide portion of the hydrogen peroxide donor, the molar ratio is from about 50:1 to 1:2 respectively; and
wherein the biocide solution forms reactive oxygen species when contacted by microorganisms, proteinaceous substances, and reducible organic based contaminants, and wherein the weight percent being based on the total weight of the biocide solution.

16. The biocide solution according to claim 15, wherein the hydrogen peroxide donor is selected from at least one of sodium perborate and sodium percarbonate.

17. The biocide solution according to claim 15, wherein the hydrogen peroxide donor is selected from at least one of sodium peroxide and hydrogen peroxide.

18. The biocide solution according to claim 15, wherein the hydrogen peroxide donor is selected from a percarboxylic acid donor.

19. The biocide solution according to claim 15, further comprising an acid donor.

20. The biocide solution according to claim 19, wherein the acid donor is succinic acid.

21. The biocide solution according to claim 15, wherein the polyoxychlorine donor is selected from at least one of an alkali and alkali earth metal of chlorite, alkali and alkali earth metal of chlorate, and alkali and alkali earth metal of perchlorate.

22. The biocide solution according to 15, wherein the polyoxychlorine donor is selected from at least one of an alkali and alkali earth metal of chlorate and alkali and alkali earth metal perchlorate, and comprises at least one polyoxychlorine donor selected from an alkali and alkali earth metal chlorite.

23. The biocide solution according to claim 21, wherein the polyoxychlorine donor is selected from at least one of sodium chlorite, potassium chlorite, calcium chlorite, magnesium chlorite, sodium chlorate, potassium chlorate, calcium chlorate, magnesium chlorate, sodium perchlorate. potassium perchlorate, calcium perchlorate, magnesium perchlorate.

24. The biocide solution according to claim 22, wherein the polyoxychlorine donor is selected from at least one of sodium chlorite, potassium chlorite, calcium chlorite, magnesium chlorite, sodium chlorate, potassium chlorate, calcium chlorate, magnesium chlorate, sodium perchlorate. potassium perchlorate, calcium perchlorate, magnesium perchlorate.

25. The biocide solution according to claim 15, wherein the molar ratio of oxygen bound to the anion portion of the polyoxychlorine anion donor and the hydrogen peroxide portion of the hydrogen peroxide donor is from about 20:1 to 1:1.

26. The biocide solution according to claim 15, wherein the biocide solution further comprises at least one of chlorous acid and chlorine dioxide.

27. The biocide solution according to claim 15, wherein the biocide solution is substantially free of chlorine dioxide.

28. A method of killing microorganisms comprising:
forming a biocide solution by adding water to a composition comprising:
a hydrogen peroxide donor;
a polyoxychlorine anion donor;
the proportion of polyoxychlorine anion donor being based on the molar ratio of oxygen bound to the anion portion of the polyoxychlorine anion donor and the hydrogen peroxide portion of the hydrogen peroxide donor, the molar ratio is from about 50:1 to 1:2 respectively;
the biocide solution comprising at least 0.5 wt % of the composition; and
wherein the biocide solution forms reactive oxygen species when contacted by microorganisms, proteinaceous substances, and reducible organic based contaminants;
contacting a microorganism with a biocidally effective amount of the biocide solution to kill the microorganism.

29. The method according to claim 28, further comprising diluting the biocide solution to form a dilute biocide solution and contacting the microorganism with a biocidally effective amount of the dilute biocide solution to kill the microorganism.

30. The method according to claim 28, wherein the hydrogen peroxide donor is selected from at least one of sodium perborate and sodium percarbonate.

31. The method according to claim 28, wherein the hydrogen peroxide donor is selected from at least one of sodium peroxide and hydrogen peroxide.

32. The method according to claim 28, further comprising an acid anhydride.

33. The method according to claim 28, further comprising an acid donor.

34. The method according to claim 28, wherein the polyoxychlorine donor is selected from at least one of: an alkali and alkali earth metal of chlorite; an alkali and alkali earth metal of chlorate; and an alkali and alkali earth metal of perchlorate.

35. The method according to claim 34, wherein the polyoxychlorine donor is selected from at least one of sodium chlorite, potassium chlorite, calcium chlorite, magnesium chlorite, sodium chlorate, potassium chlorate, calcium chlorate, magnesium chlorate, sodium perchlorate. potassium perchlorate, calcium perchlorate, magnesium perchlorate.

36. The method according to claim 28, wherein the polyoxychlorine donor is selected from at least one of: an alkali and alkali earth metal of chlorate; and alkali and alkali earth metal perchlorate.

37. The method according to claim 28, wherein the molar ratio of oxygen bound to the anion portion of the polyoxychlorine anion donor and the hydrogen peroxide portion of the hydrogen peroxide being about 20:1 to 1:1.

38. The method according to claim 28, wherein the biocide solution further comprises at least one of chlorous acid and chlorine dioxide.

39. The method according to claim 28, wherein the biocide solution is substantially free of chlorine dioxide.

40. The method of claim 28, wherein the solid composition is in the form of a powder.
